(19) United States
(12) Patent Application Publication
(10) Pub. No.: US 2025/0173775 A1
(43) Pub. Date: May 29, 2025

(54) FITMENT BASED PRODUCT SEARCH AND FILTERING

(71) Applicant: GroupBy Inc., Toronto (CA)

(72) Inventors: Roland Gossage, Toronto (CA); Daniel Moniz, Toronto (CA); Henry Tang, St. Catharines (CA)

(21) Appl. No.: 18/962,066

(22) Filed: Nov. 27, 2024

Related U.S. Application Data
(60) Provisional application No. 63/603,225, filed on Nov. 28, 2023.

(51) Int. Cl. G06Q 30/0601; G06F 16/9535

(52) U.S. Cl. CPC G06Q 30/0631; G06F 16/9535; G06Q 30/0603

(57) ABSTRACT

Parts or components may have specific fitment requirements. For example brake pads may only fit certain years/makes/models of cars, computer parts may fit with other specific parts, etc. Parts can be associated with fitment details and used to filter search results against values from a search query.

### RELATED APPLICATIONS

The current application claims priority to U.S. Provisional Patent Application No. 63/603,225 filed Nov. 28, 2023, entitled “Fitment Based Product Search and Filtering,” the entire contents of which are incorporated herein by reference in their entirety for all purposes.

### TECHNICAL FIELD

The current disclosure relates to product searching systems and in particular to searching systems for products with particular fitment requirements.

### BACKGROUND

Product search is important for online shopping. A user may wish to purchase a product that is compatible with another product. For example, a user may wish to search for brake pads that fit their particular car. Such searching is often provided through the use of a plurality of selections. For example a user may select a year, make and model of their car and provide a search query for the product they are looking for, such as brake pads. While such selection and searching can provide acceptable results, it can present a cumbersome user interface for the user.

An additional, alternative, and/or improved system for searching for products that are compatible with an entity is desirable.

### BRIEF DESCRIPTION OF THE DRAWINGS

Further features and advantages of the present disclosure will become apparent from the following detailed description, taken in combination with the appended drawings, in which:

FIG. 1 depicts components of a fitment search system;

FIG. 2 depicts ingestion of data into the fitment search system;

FIG. 3 depicts a data model for a fitment search system;

FIG. 4 depicts processing a user input query;

FIG. 5 depicts a method for fitment based product searching;

FIG. 6 depicts a vector search for filter normalization; and

FIG. 7 depicts fitment search process.

### DETAILED DESCRIPTION

In accordance with the present disclosure there is provided a method of searching comprising: receiving a raw search query comprising a plurality of terms from a user; processing the raw search query by a large language model (LLM) in order to identify one or more product terms of a product being searched and one or more attributes specifying fitment requirements of the product; performing a vector search for the one or more attributes against a vector database of fitment terms to provide one or more verified fitment attributes, as first subset of the verified fitment attributes providing main fitment data and a second subset of the verified fitment attributes providing additional fitment data; performing a filtered product search using the identified one or more product terms as search terms and the main fitment data as a filter, the filtered product search providing a plurality of products matching the search terms and the filter; and returning the plurality of products to the user.

In a further embodiment of the method, the method further comprises: determining a fit of each of the plurality of products using the additional fitment data; and returning the fit of each of the plurality of products to the user.

In a further embodiment of the method, the fit of each of the plurality of products is determined to be one of: guaranteed fit; possible fit; and does not fit.

In a further embodiment of the method, the fit of at least one of the plurality of products is a possible fit, the method further comprising: determining one or more fitment attributes required to provide a guaranteed fit.

In a further embodiment of the method, the method further comprises burying/boosting one or more of the plurality of products in the search results.

In a further embodiment of the method, the search is performed against a product catalog comprising a plurality of products each associated with one or more fitment values of entities the respective product is compatible with.

In a further embodiment of the method, a response from the LLM is cached.

In a further embodiment of the method, the method further comprises determining if the received raw search query has been previously cached.

In a further embodiment of the method, returning the plurality of products to the user comprises returning product metadata pertaining to the one or more attributes specifying fitment requirements of the product

In a further embodiment of the method, returning the plurality of products to the user comprises returning metadata and state information based on processing of the raw search query by the LLM.

In a further embodiment of the method, the method further comprises ingesting product information comprising a product information about a plurality of products, the product information including fitment attributes.

In a further embodiment of the method, the fitment attributed associated with a product specify entity information that the product fits.

In a further embodiment of the method, the fitment attributed associated with a product specify that the product is a universal fit.

In accordance with the present disclosure there is further provided a non-transitory computer readable medium comprising instructions which when executed configure a computing system to perform a method according to any of the methods described above.

In accordance with the present disclosure there is further provided a computer system comprising: at least one processor for executing instructions; and at least one memory storing instructions, which when executed configure the computing system to perform a method according to any of the methods described above.

Products or components may fit a particular entity. For example, car parts may fit one or more particular year, make and model of car; certain computer components may fit or work with other computer components, etc. As described further below, a fitment search allows a user to provide a query term that includes both information about the product being searched for as well as details about the entity the product will be used with. The query term can be provided to a large language model that is able to identify the product information and the entity fitment details. The product information is used to search a product database for matching products and the fitment details is used to filter out products that are not compatible with the entity. The fitment details may be used to further evaluate the fit level of the product or products with the entity. For example, a product may be guaranteed to fit with a particular entity, or it may be a possible fit, or it does not fit. The products, along with the fit information may be returned to the user.

Allowing a user to enter a text search that includes both the product and fitment information can provide a more desirable user interface compared to selecting specific entity details separately can provide an improved user experience, doing so may make filtering for correct parts more difficult as the fitment details of the entity may not be consistently spelled, or provided by a large language model processing the user input. In order to normalize the entity details a vector search of the fitment information is performed to determine the most similar fitment information from the actual fitment information used by the product specifications.

In describing the fitment search system, it is assumed that a user is attempting to search for some part or product that fits a specific product or class of products. In order to distinguish between the part or products being searched for and the specific product or class of products they should fit or be compatible with, the product being searched for is referred to the product or part while the product that it should fit is referred to as the entity. For example, in a case of a user searching for brake pads to fit a particular car, the brake pads would be the product and the particular car the brake pads are to fit would be the entity. The products may fit one or more entities. The entities that a product may fit may be specified as fitment requirements, which specify one or more compatibility values of compatibility attributes for the entity. Continuing with the brake pad example, the compatibility attributes may be, for example, the year, make and model of vehicles the brake pad will fit. Accordingly, the particular brake pad may specify the values that it will be compatible with such as 2020 Toyota Corolla vehicles. The fitment search system allows for a user to enter a single search query such as “2020 Toyota Corolla Brake Pads” or “brake pads for Toyota Corolla 2020” or similar search terms in order to locate brake pads that fit a 2020 Toyota Corolla. The fitment search system is described further below with particular reference to an example of searching for parts for a vehicle in an online store; however, the fitment search system can be applied to a wide range of applications in which it is desirable to search for products that fit a particular entity.

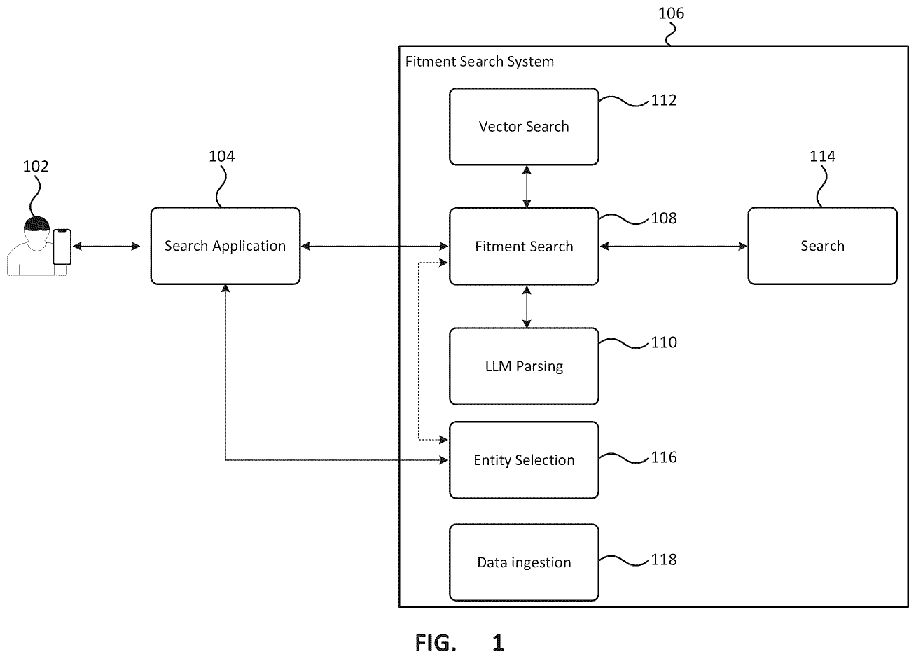

FIG. 1 depicts components of a fitment search system. As depicted in FIG. 1, an end user 102 may access a search application 104 which may be for example an online store, web site or application for selling products, etc. FIG. 1 depicts the user 102 as using a mobile phone to access the search application, however, it will be appreciated that different computing devices may be used by the end user to access the search application. Further, while the search application, and the fitment search described herein, may be useful on its own to locate products, it may be incorporated into an online store or purchasing functionality in order to allow the end user to purchase the products. It will be appreciated that the search application can generate a graphical user interface to the end user on their device, or other interfaces may be used for product discovery including, for example a vocal interface. Further, although not depicted in FIG. 1 it will be appreciated that the search application and fitment search system are provided on one or more computing devices, such as one or more servers, that are appropriately programmed to provide the functionality described herein.

The end user 102 enters a raw search query comprising a text string, which includes one or more product terms as well as zero or more attribute values of the entity the products are to fit. The raw search query is provided to the search application 104 which in turn provides the raw query to a fitment search system 106. Although not depicted in FIG. 1, it will be appreciated that the search application functionality 104 as well as the fitment search system 106 may be provided by one or more computing devices. The computing devices may be a single computing device or a plurality of computing devices coupled together.

The fitment search system 106 comprises fitment search functionality 108 that receives the raw search query and controls processing of the search. The fitment search functionality 108 may be passed to a large language model (LLM) parsing functionality 110 that processes the query in order to identify product terms and fitment data from the raw query. Although depicted as being part of the fitment search system, the LLM parsing functionality may be provided by an external system or provider. With the raw search query parsed into the product terms and fitment data, the fitment data may be used by vector search functionality 112 which uses a vector search to conform the formatting, wording, spelling etc. of the fitment data to the fitment data actually used by the products. As an example, the product fitment data for products may specify a particular vehicle as a “Ford F150”, while the user may specify the fitment data as “Ford F-150”. The vector search functionality conforms the user entered terms, such as “Ford F-150”, to the terms used with the products, such as “F150”.

With the product terms from the LLM parsing functionality 110 and the conformed fitment data from the vector search, the fitment search may form a search query for search functionality 114. The search query may comprise the product terms as the search terms and the entity fitment data as filters for the results. The filters provide the compatibility attributes of the entity the product being searched for should fit. The search functionality returns the filtered search results to the fitment search functionality.

It is possible that the user's search did not provide values for all of the attributes of the fitment data. In such a case, the search functionality 114, or the fitment search functionality may determine which attributes were missing from the fitment data. The missing information may be sent back to the search application 104 and used to determine possible values that could be used to further specify the entity. The fitment search system may include entity selection functionality 116 that can determine possible values for the missing fitment attributes that the user may specify or select the details of the entity.

The fitment search system 106 may include data ingestion functionality 118 that processes product data, including fitment data in order to ingest the products into the search system. The product data may be provided from various sources, such as product catalogues, inventory data etc.

The search application 104 may be provided as part of an online store. The search application may be provided in various ways, including as part of a client application, or as part of the fitment system infrastructure, or other implementations. The online store may be a combination of different frontend and backend systems that in the scope of this system are used to make requests to the overall fitment system. A request is received from an online store to the fitment search system. If the request indicates that fitment should be skipped, the request is simply forwarded to a search subsystem.

If the fitment search is enabled the fitment search system may perform a standard, non-fitment search to a search system, and also parse the query for possible intent to determine if a fitment search should be performed. If the user is searching for a car part and also includes information about their car, an attempt to parse out that car information (e.g. year/make/model) is made. If car information is not found, then the results of the non-fitment based search can be returned. If fitment information, such as car details, is found, the query, such as “2017 Toyota corolla brake pads”, is used to obtain parsed car information, possibly from a cache or determined using a large language model. The parsed data, whether newly parsed using the LLM or from the cache, may contain values that do not match the client's data. The LLM may produce a value for a compatibility attribute that is similar to but not the same as data in the product catalog. In order to use the results from the LLM, a vector search may used to compare each parsed compatibility attribute to a database. This database is based on catalog data such that any values in it represent canonical catalog data. A vector search can provide the closest matching compatibility attribute, allowing each parsed attribute to be corrected to a valid catalog-based value. These corrections decrease the chance that the parsed values, when used as filters in a search, produce zero results due to not matching catalog data. The vector search of the database based on the canonical catalog data enables the use of the LLM to process the raw query to split the query into fitment information and product information. Combining the LLM processing with the vector search enables the searching for products that fit a specific entity using more natural language. The vector search conforms the processing of the raw search by the LLM to conform to the canonical catalog data which simplifies the searching and filtering for specific products or parts.

If the system succeeds in determining that the user's query contains information about an entity, such as a car, a fitment search is performed. This is a request to the search system that includes a number of filters based on the information parsed about a shopper's car. The system either responds with no products if there are none that match the provided filters, or it responds with some number of products. The response may include information about the products as well as possibly other information that may be useful to the search application or online store. The response may include, among other possible information:
Products/parts
   A list of parts. These parts are compatible with the provided filters.
   The parts contain additional information above and beyond what is in the catalog:
      Whether or not the part is guaranteed to fit.
         This value is true if the part has Guaranteed Fit and false if it Might Fit or Does Not Fit.
      A list of attributes needed to guarantee fit.
         This list is omitted if the part has Guaranteed Fit.
         If the list is non-empty, it indicates that the part Might Fit.
Car information
   This describes the car data used to make the search. For example, year: 2017, make: Honda, model: civic.
The inferred shopper query
   The LLM is asked not only to parse out information about the car, but to place any other text in an ‘other’ category. This becomes the inferred shopper query.
   For example, “brake pads”.

This response may be provided to the online store, or search application, which may then display the products, ask for more information as needed, and place badges on any products that have Guaranteed Fit/Might Fit/Do Not Fit.

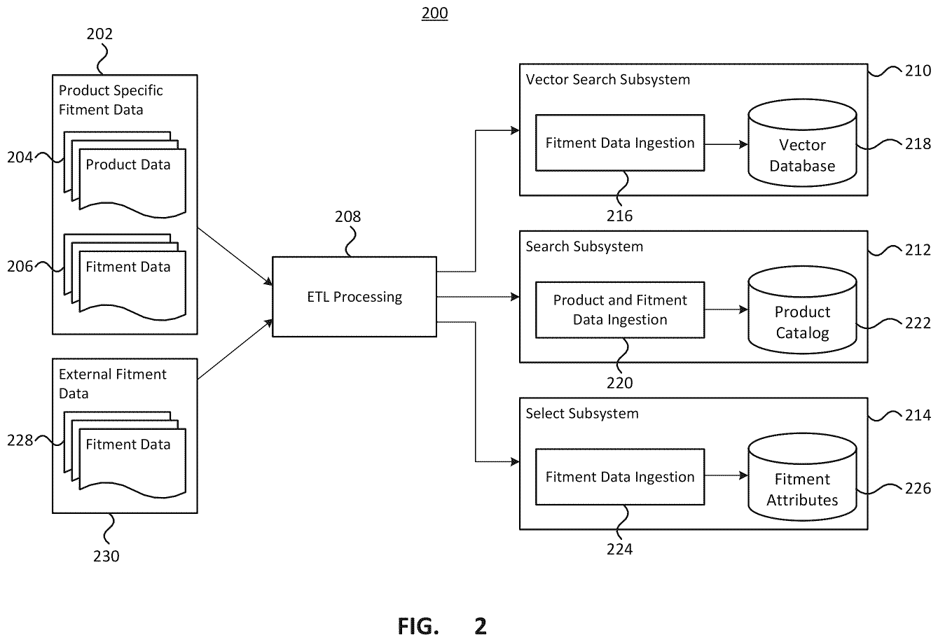

FIG. 2 depicts ingestion of data into the fitment search system. The data ingestion depicted in FIG. 2 may be used as the ingestion functionality of FIG. 1. The data ingestion ensures that the data powering all of the different subsystems of the fitment search are based on the same data set and are modeled using a consistent data model.

Base data 202 which provides both product data 204 and associated fitment data 206 may exist as a single or multiple files. At a minimum, the ingestion system processes the product data 204 and fitment data 206 used by the fitment search, but may also ingest additional information, not depicted, such as inventory information, additional product information, pricing information, etc. The product and fitment data 202 is provided to extract, transform, load (ETL) processing functionality 208. The ETL processing extracts the root data and transforms it into a format that is parsable by fitment search subsystems, including a vector search subsystem 210, search subsystem 212 and entity selection subsystem 214.

The vector search subsystem 210 uses data for matching user-entered fitment data against how the fitment data is defined in the root fitment data 206. Accordingly, only the raw fitment data 206 is required to be ingested 216 into the vector database 218 used by the vector search. The fitment data may be ingested, and stored, as different permutations of the main fitment attributes of the entity. For example, with vehicles, the main fitment attributes may be the year, make and model of the vehicle. The ingestion may store the fitment data as different permutations of the data such as Year Make Model, Year Make, Make Model, etc., which allows the terms to be interpolated regardless of how many fitment contexts are parsed from the user's input. For example, by storing fitment data for a “2020 Ford F150” as “2020 Ford F150”, “2020 Ford”, and “Ford F150”, the vector search may be used to conform search queries that may specify different combinations of the compatibility values such as “Ford F-150” or “2020 Ford”. It will be appreciated that the fitment data may be stored and queried in various different ways based on the data model used.

The search subsystem 212 ingests 220 both the product data and fitment data and generates and stores the fitment data in a specific format so fitment compatibility can be determined. The inputs into the search subsystem during application runtime are both the user's product term(s) as well as entity fitment data. The underlying data is formatted according to a data model to allow the fitment data to be used for filtering search results. When data is ingested into the search subsystem, it is transformed according to the data model and stored in a product catalog database 222. This product catalog database may exist as some kind of persistence system like an RDBMS or Columnar storage engine; or may exist as an external application runtime as well like a third party API such as the Google Retail API.

The entity selection subsystem 214 ingests 224 fitment data and generates different permutations of the main fitment attributes of the entity, which may be stored in a fitment attributes database 226. These different permutations are used to power different selection options that may be displayed to end users to assist in helping select proper main fitment attribute combinations. When ingesting the fitment data 206 to populate fitment data store 226, product specific fitment options may be used in conjunction with fitment option data extracted from a third party or external service/subsystem 228 comprising the fitment data 230. The entity selection subsystem may assist an end user using the select subsystem to include combinations of main fitment attributes that are available based on the root product data availability, as well as other valid combinations of fitments that do not result in product availability against the root product data. For example, the entity selection subsystem may provide combinations of main fitment attributes based only on products that a store sells and are in stock, or may include products that are not in stock.

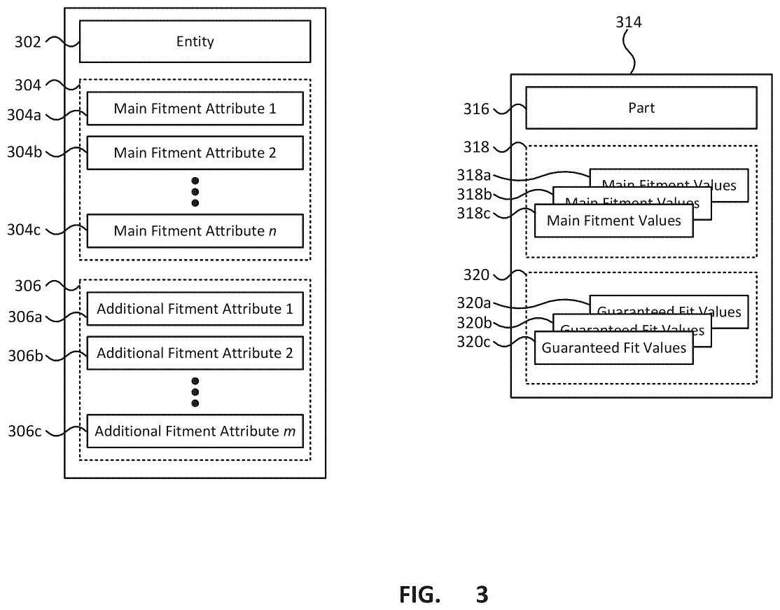

FIG. 3 depicts a data model for a fitment search system. Broadly, an entity 302 is associated with fitment attributes that are used to specify which parts are compatible with the entity. The fitment attributes may be grouped into main fitment attributes 304, comprising one or more individual attributes 304a, 304b, 304c and additional fitment attributes 306 comprising zero or more additional fitment attributes 306a, 306b, 306c. The main fitment attributes 304 are used as filters for filtering parts that fit the user's specified entity. In the example of a car, these attributes may include the year, make and model of the vehicle. The additional fitment attributes may comprise additional attributes of the entity that may be necessary to ensure a part or product fits with a particular entity. In the case of a car this could include for example trim level, engine type, engine size, transmission, etc. It will be appreciated that although the entity information is depicted as part of the data model, the fitment search system does not need to store information about the entities. For example, the search system does not need to store records about all different cars.

As depicted, a part record 314 specifies part information 316 such as a description of the product as well as other information such as availability, price, etc. Additionally, each record includes fitment data specifying the entities that the part is compatible with. The fitment data comprises main fitment values 318 that are used to filter product results. The main fitment values 318 can specify a plurality of different fitment values 318a, 318b, 318c for the main fitment attributes of the entity it is compatible with. The fitment data may further comprise guaranteed fit values 320 specifying a plurality of values 320a, 320b, 320c for guaranteed fitment attributes of entities the product is compatible with.

As depicted in FIG. 3, each product or part record may specify one or more entities the part fits with, or is compatible with, in the fitment data, which may comprise main fitment values and guaranteed fit values. Returning to the brake pad example, a particular brake pad may specify the year, make and model of vehicles the brake pad fits. The main fitment attributes/values are used to filter search results for those products that will fit the specified vehicle. It is possible that in order to guarantee a fit between a product and entity additional fitment attributes/values need to be specified. For example, with cars, the guaranteed fitment attributes may be the trim level, engine type etc.

The fitment attributes and values may be stored in various ways in the fitment search system. As described above, the product data may be ingested into different subsystems of the fitment search system from a catalogue, or other data sources. When this data is ingested, it is used to build a parts catalog that allows for searching for products and both filtering the parts based on entity information and determining whether they are guaranteed to fit (or do not fit). This is done in two ways. First, data is stored in association with the record of a part about its most fundamental compatibility, namely the values of the main fitment attributes for compatible entities. Second, data is separately stored in association with the record about what it requires for a guaranteed fit, namely the guaranteed fitment attributes/values. This information may be stored in various ways.

The main fitment attributes/values provide the data needed to filter products on the most fundamental compatibility attributes. In the case of cars, this tends to be year, make, and model, but could include other attributes as well. These values allow for filtering on the record. In order to allow for record filtering, the data can be stored in a series of arrays, for example called ymm_1, ymm_2, ymm_3 and so on. The names of these arrays are unimportant, but here are used to refer to year/make/model. They can store more information than that if required. Arrays can used instead of individual attributes in order to bypass potential overall attribute limits a system may have. Multiple arrays can be used in order by bypass limits on the number of items in an array. That is, if the number of items required to be specified exceeds the array length, a second array can be added.

An example array, assuming the main fitment attributes are the year, make and model, may be:

```
ymm_1: [
  “2007_Dodge_Magnum”,
  “2007_Dodge_Magnum_3.5 L 215 CID V6 SOHC 24 Valve”,
  “2007_Dodge_Charger”,
  “2007_Dodge_Charger_3.5 L 215 CID V6 SOHC 24 Valve”,
  “1998_Chrysler_Concorde”,
  “1998_Chrysler_Concorde_3.2 L 197 CID V6”,
  . . .
]
```

These values can be added to guaranteed_fit arrays in the same way as the ymm arrays; that is, continue adding values to guaranteed_fit_1 until it hits its array maximum, then add to guaranteed_fit_2, and so on.

The guaranteed fit entries are selected such that the entity in question is maximally specified. Values are left out only if they are irrelevant to the part's fit. In the example of cars, if a part fits most 2017 Honda Civics, but not those of a submodel, then 2017/Honda/Civic/[submodel] needs to be listed out.

Note that not all attributes are needed. If a key, for example, key2 is not required to specify guaranteed fit for a particular part, it can be left out. These values can then be broken down into a meaningful key-value map elsewhere in the fitment search system.

In cases where a part fits all possible entities-a “universal” part-a single guaranteed_fit array can be used with a single value: “All_All_All_”. If the system encounters this value, it can return the part record and be confident that the part has Guaranteed Fit due to its universal nature.

An example of a guaranteed_fit array is:

```
guaranteed_fit_1: [
  “2010_Mercedes-Benz_B200_engine|2.0 L 2034 CC
  L4_engine
  aspirations|Naturally Aspirated”,
  “2008_Mercedes-Benz_B200_engine|2.0 L 2034 CC
  L4_engine
  aspirations|Naturally Aspirated”,
  “2007_Mercedes-Benz_B200_engine|2.0 L 2034 CC
  L4_engine
  aspirations|Naturally Aspirated”,
  “2009_Mercedes-Benz_B200_engine|2.0 L 2034 CC
  L4_engine aspirations|Naturally Aspirated”,
  “2006_Mercedes-Benz_B200_engine|2.0 L 2034 CC
  L4_engine_aspirations|Naturally Aspirated”,
  “2011_Mercedes-Benz_B200_engine|2.0 L 2034 CC
  L4_engine
  aspirations|Naturally Aspirated”,
  . . .
]
```

Entries should be selected precisely so that a guaranteed fit is actually guaranteed. Each compatibility entry for each part becomes a value in a guaranteed_fit array for the part. Any guaranteed_fit values can become long, even when using the key-value system for non-fundamental compatibility attributes. If there are enough attributes required to specify compatibility, the values can, for example, exceed database limits on value length. To reduce the length of guaranteed_fit values, short versions of each key can be created. If there are fewer than 26 possible attributes, for example, each attribute can be renamed to ‘a’, ‘b’, and so on. This can lead to values that look as follows:
“2010_Mercedes-Benz_B200_a|2.0 L 2034 CC L4_b|Naturally Aspirated_c|18w_d| . . . ”,

The mapping between the long keys and the shortened keys can be stored and used to switch between the two. Other approaches for shortening key|value pairs are possible.

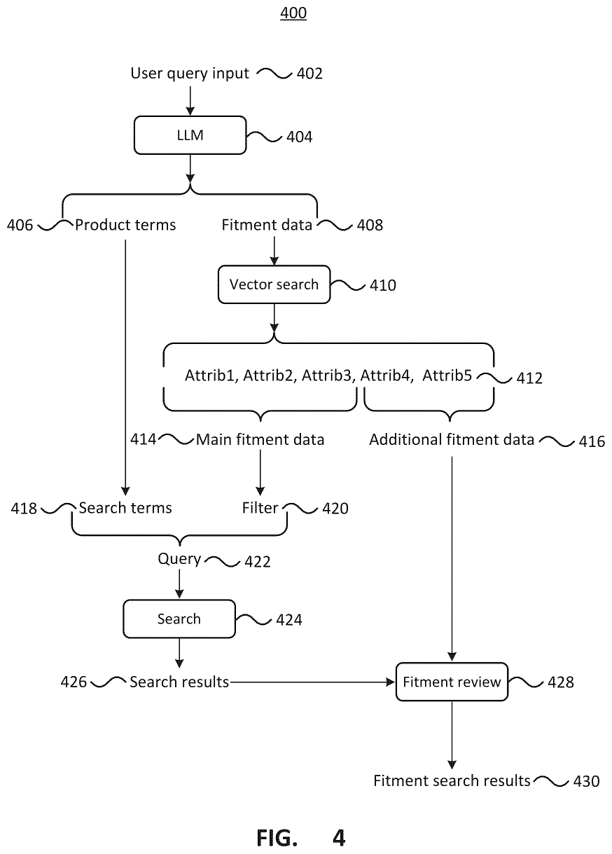

FIG. 4 depicts processing a user input query. The process begins with receiving a user's input query 402. The input query is a text string and can be processed by a large language model 404 in order to parse the input query into product terms 406 that the user is searching for, which may also be referred to as the user context or intent, as well as fitment data 408. For example, the user may enter the query term “Brake pads for a 2018 Ford F-150 XLTs”, and the LLM may parse the text to identify the user's intent as searching for “Brake pads” and the fitment data as “2018 Ford F-150 XLTs”. The LLM may be provided with a prompt using the user's query that causes the LLM to parse the query into the respective parts. The parsed fitment data may then be used for a vector search 410 against a vector database generated from the fitment data of products during the data ingestion. The vector search determines the actual fitment data used in the search system that is closest to the user's specified fitment data. The vector search 410 provides one or more attribute values 412 of fitment data. The attribute values may comprise main fitment data 414 and additional fitment data 416. The vector search may process the fitment data of “2018 Ford F-150 XLTs” to provide the main fitment data of “2018 Ford F150” and the additional fitment data as “Submodel_XLT”.

A search query is formed with product search terms 418 and filters 420 for filtering the initial search results. The search terms 418 are provided by the product terms 406 and the filters are provided from the main fitment data 414. The query 422 is provided to the search system which searches for products matching the search terms, filters the initial results using the filter and then returns the search results 426.

The search results 426 include the guaranteed fitment data of each product. A fitment review process 428 uses the guaranteed fitment data of the result determine if each product is guaranteed to fit, might fit, or does not fit, the provided fitment data from the user. The fitment review process determines the fit using the additional fitment data 416. The fitment review process may add additional information to the search results providing an indication of whether the fit is a guaranteed fit, possible fit, or not a fit. The fitment search results 430 may be returned to the user. In the case of a possible fit, it is possible to determine which additional fitment information would be required to provide a guaranteed fit.

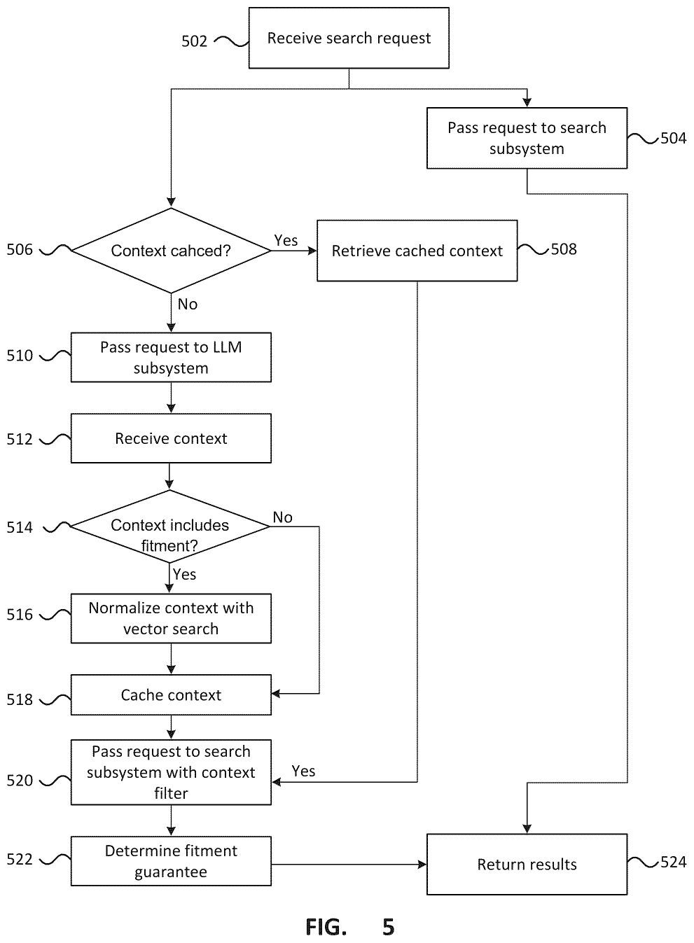

FIG. 5 depicts a method for fitment based product searching. The method 500 includes both a regular search as well as a fitment based search. A search request is received (502) and passed to a search subsystem (504). The search may not include fitment data and as such should be treated as a regular query. In addition to sending the query to the search system, the query is processed to parse the fitment context, if any. The query is checked against a cache (506) to determine if the fitment context of the query was previously determined and cached. If the fitment context was previously cached (Yes at 506), the cached context is retrieved (508). If the context is not cached (No at 506), a prompt is generated using the query and is passed to a large language model (510) for parsing. The parsed context from the LLM, comprising the user's intent and fitment data, is received (512) in response to the prompt. With the context provided from the LLM, it is determined if the context includes fitment data (514) and if it does (Yes at 514) the context is normalized using a vector search against a vector database of fitment data used by the search system. The normalized context, or the context if the context did not include fitment information (No at 514), is cached (518). The context, whether retrieved from the cache (508) or recently determined is used in passing a product search request along with a filter using the fitment data from the context. The search request and filter are passed to a search subsystem (520) which determines matching products and filters them. The products are returned along with guaranteed fitment data and used to determine a fitment guarantee (522) using additional fitment data from the user's query. The results of the search, whether from the fitment search (522) or the regular search (504) may be returned to the user.

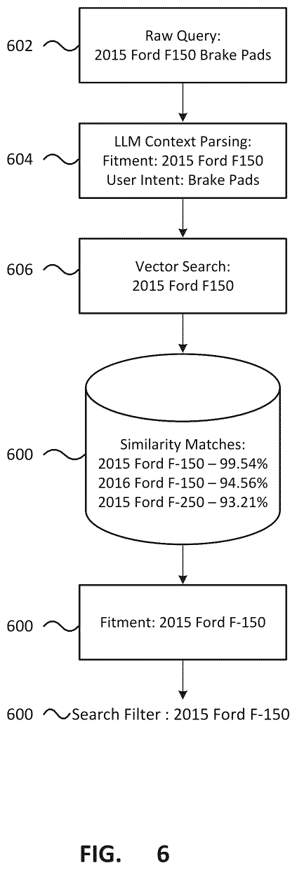

FIG. 6 depicts a vector search for filter normalization. As depicted a raw query 602 may be received. The raw query may be a text string that includes product terms for searching for a desired product and possibly fitment terms specifying attributes of an entity that the product should fit or be compatible with. For example the raw query may be “2015 Ford F150 Brake pads”. The query can be processed by a large language model in order to determine the user's intended product as well as fitment information that may include both main fitment data as well as additional fitment data. The LLM may parse only certain attributes from the query. The example query only includes main fitment data, however, additional fitment data could specify additional fitment attributes such as engine type, trim level, etc. The fitment data may be used for a vector search 606 to normalize the fitment data against the attributes and values used in the search system.

Because of the nature of the fitment modeling, exact matches are required for guaranteed fit and all of its constituents. The nature of the system with having some input coming from a user's context query and then to an LLM system adds potential for non-deterministic results and permutations of different compatibilities. For example, a Ford F-150 can be described as both Ford F150 and Ford F-150 and still be considered correct and contextually mean the same thing. In order to help circumvent this issue, a vector based matching algorithm is used to find the most similar context given the merchant's actual input data ingested into the fitment search system. This may be particularly useful with complex and lengthy values such as engine model names, or commonly misspelled values. The likelihood of systematically incorrect values can be low when using a powerful LLM, but the mistakes may consistently fail to match data in the client's catalog (such as in the Ford F-150 example).

After parsing a shopper's query into various entity attributes (year/make/model/etc.), each can be checked against a database of valid values. This database can be based on the product catalog's values, producing a canonical database of valid attribute values. For each attribute (e.g. submodel), a vector search is performed against all valid values of that attribute in the database. The vector search can return a list of possible matches ordered by some percentage match probability (e.g. “closeness”). This provides the system two options:
If the probability of the closest match is too low, based on a configurable number—e.g. less than 70%—the system can disregard the value as a special compatibility attribute, and it can instead be parsed into the “other” category.
Otherwise, select the highest match and correct the parsed value accordingly.

In correcting LLM-parsed values into catalog-canonical values with a vector search, the chance of parsed attributes being mismatched becomes negligible. This technique also allows for compatibility with many varying product catalogs. Since the catalog values as ingested are used as the canonical values, if the client's catalog has inconsistent values for various attributes, they should be identified and normalized for this technique to be most effective.

As depicted in FIG. 6, the vector search may provide a match percentage of various similar attributes 606 and the closest match selected for the fitment data 608, which may be subsequently used as a search filter.

The above has described performing individual vector searches on attributes. It will be appreciated that one or more attributes could be combined together and a single vector search provided for the combined attributes. For example individual vector searches could be performed for Make=Ford and Model=F-150. Additionally or alternatively, the two attributes could be combined together and a single vector search for Make_Model=Ford F-150.

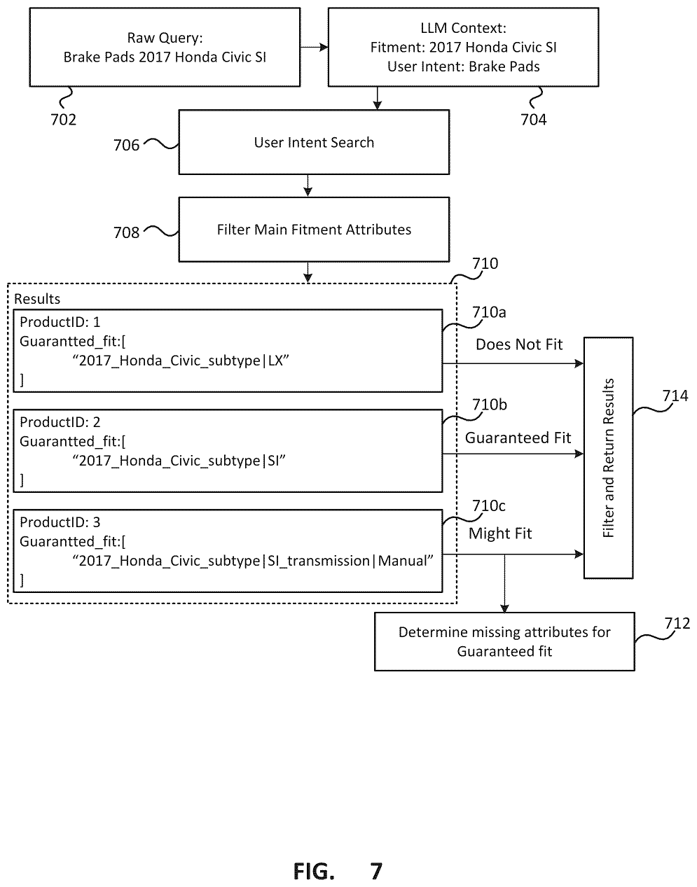

FIG. 7 depicts fitment search process. The process 700 receives the raw query 702, which may be processed by a large language model to identify the user's intent of the search along with fitment data 704.

When a shopper's query is sent to the fitment search system, it attempts to determine the shopper's intent. In the case of fitment searches, there are a few common use-cases. The shopper might be trying to:
Search for a part and specify entity information, which may be complete or incomplete;
Search for a part with a selected entity;
Search for a part with no entity; and
Search for a universal part.

This determination is made as soon as possible when the request is received and is handled by artificial intelligence (AI). In particular, LLMs (Large Language Models) are very suitable for this role, but other systems can alternatively be used. The system therefore prompts the AI model to parse the shopper's text query into various components. For example, in the case of cars, it might attempt to break down a query into:
Year
Make
Model
Submodel
Other

Notice the fundamental compatibility attributes year/make/model, followed by submodel, the latter which is commonly used with vehicles. Note that engine type is also common, but left out due to written complexity of the different engine types. It is very unlikely the shopper is able to describe their specific engine type. The “other” category is intended to be everything else from the raw query; in short, the shopper's actual parts query.

For example, if the shopper's text query was “2017 Honda civic brake pads”, the system might determine:
Year: 2017
Make: “Honda”
Model: “Civic”
Submodel: null
Other: “brake pads”

Spelling corrections are possible at this stage, as are the removal of stop words and other query cleanup such as capitalization, normalization against a catalog using a vector search or other techniques, and more. This can involve multiple systems and services or be performed by a single LLM or AI component depending on requirements.

The first use-case of searching for a product along with specifying entity information in the query, allows for seamlessly detecting both the entity and part based on a shopper's query.

When the shopper's query provides complete information about the entity, such as “2017 Honda Civic brake pads”, the system can parse the correct entity and the actual intended query. It can then perform a fitment search using information on both.

In the case that the shopper provides incomplete information, for example, “Honda civic brake pads”, the query is missing a year, which might be required for the particular fitment domain of cars. The system may perform a standard non-fitment search while attempting to parse the shopper's query. After parsing and determining that the entity information is incomplete, the system can perform a fitment search using the incomplete information, which at least partially filters the search by the shopper's intended entity. It can also build the search response to include some meta information specifying that not all of the required fitment information was provided along with what fitment attributes were missing. For example:
A “year” attribute in a returned fitment Object can have a null value indicating that it was missing.
A flag can have a value set to indicate that the search was incomplete and more information is needed. An example value might be FITMENT_INCOMPLETE_SEARCH.

In this case, the store can use this information to automatically select the relevant entity information if possible, for example, if they have a manual dropdown-based car selector. This may not be possible depending on the missing information. It can also provide a message that informs the shopper to be more specific in their search, thereby training a store's users to utilize these time-saving features more frequently.

Rather than specifying entity information in the search query text, the user may select the entity information from drop down menus or similar interface, which provides specific entity information. In this case, the shopper has an entity selected, possibly through a specific selection interface like a series of dropdown menus. When the system receives a request containing a fully-specified entity for compatibility, it can immediately perform two actions, namely performing a fitment search using the provided entity information, and parsing the shopper's query for a possible contradicting entity.

The initial fitment search allows for a fast search using the provided information. It also allows the system to skip any parsing, which can reduce response time and cost. However, it may not make sense for the shopper. Parsing the shopper's query for a possible contradicting entity allows for handling a special case, and may only do so if enabled. For example, say the shopper has fully specified an entity using a special interface: a 2017 Toyota Corolla (year/make/model). However, the user may own another vehicle and wish to search for that vehicle instead. They might search for “2013 Honda Civic brake pads”. They may even be attempting to correct some mistakenly selected information.

In this case, the system receives two apparently contradictory pieces of information: the selection data for one vehicle, and a query that describes a second vehicle. In the case that there is contradictory entity information, and assuming a contradiction feature is enabled—the system can check for a successful parsing. If a new complete vehicle is described, the system can then perform a search based on information for the new entity. It will return results accordingly, and as normal, it will return information about which vehicle it searched.

This allows the store to automatically inform the user that their new entity was successfully determined. The store may automatically select that entity for future searches, allowing the user to revert to searching without specifying their entity for compatibility (e.g. “brake pads”).

A common use-case is when a simple search query is provided that includes no information about an entity. For example, a shopper wanting brake pads might simply search “brake pads”. In this case, the system will parse the shopper's query and determine that there is no entity information, thereby placing the entire query into “other”. In this case, a standard, non-fitment search is made due to lacking other information.

However, a flag may be set in the response indicating that no entity information was detected. In this case, a store can make domain-specific choices. For example, if the shopper has no car selected and no entity information was provided, a message can be displayed recommending that the shopper be as specific as possible in their query. Providing similar flags about system usage in the response allows for better store experiences and shopper training.

In the case that the user is searching for a universal part, the system can be informed of the desire, for example via a checkbox on a website. Otherwise, the system performs a standard fitment search and the shopper can refine their search as needed. In the case of searching for a universal part, a fitment search may be performed that ignores parts that are not universal.

The query text may be modified in order to correct spelling, formatting, etc. Correcting spelling is easiest to perform while parsing the shopper's query. Using an LLM allows for automatic spelling correction in the vast majority of cases in the same prompt as the query breakdown into attributes. Other AI-based techniques may also be used.

The user intent parsed from the query is used for a product search 706 and at least the main fitment data used to filter the results 708. The search and filtering may be provided by a search subsystem, which may be an external system.

In order to search for a product that fits a specific entity, the fitment search system passes information about what is being searched, along with filters that restrict the search or results to the relevant entity. Additionally, the search may also pass information that allows for burying products that do not fit/boosting products that fit.

Using the values parsed from the shopper's query, the “other” field may be used as the product search terms. The filtering is performed using the main fitment attributes/values and the guaranteed fit attributes/values. These different filters may be specified for each product in different arrays. In the car example, these may include the ymm_1, ymm_2, etc. arrays and the guarantee_fit arrays.

Each ymm array comprises many compatibility sets, or specifies the main fitment values of compatible entities. This data may be stored in various ways, including as underscore separated values, and so any parsed entity data may require appropriate formatting before being used as a filter.

There can be many ymm arrays. If a product is to be accepted, or not filtered out, a filter should be placed on every ymm array using the following logic. For the below example, assume the entity is described as “2017_honda_civic”. The system needs to know how many ymm arrays it should filter on. This value can be stored as the maximum possible number of ymm arrays. This works in cases where the database allows for filtering on record attributes that do not exist (and simply ignores them). Otherwise, each record should have an identical number of ymm arrays. The search includes a filer against each array such as:

guaranteed_fit_1 CONTAINS “All_All_All_” OR
ymm_1 CONTAINS “2017_honda_civic” OR
ymm_2 CONTAINS “2017_honda_civic” OR
ymm_3 CONTAINS “2017_honda_civic” OR
. . .

Notice that the first guaranteed_fit array must be checked for “All_All_All_”. This describes the case where a product has universal fit; in other words, it fits every possible entity.

In the case that another compatibility attribute is specified in the search, but that a particular product record does not require a specific submodel, the filter needs to become more complex. For this example, let's assume that the submodel of LX is also specified. The filter may be specified according to:

guaranteed_fit_1 CONTAINS “All_All_All_” OR
(ymm_1 CONTAINS “2017_honda_civic” OR ymm_1 CONTAINS
“2017_honda_civic_lx”) OR (ymm_2 CONTAINS
“2017_honda_civic” OR ymm_2 CONTAINS
“2017_honda_civic_lx”) OR (ymm_3 CONTAINS
“2017_honda_civic” OR ymm_2 CONTAINS
“2017_honda_civic_lx”) OR . .

There are cases where the data might contain a fourth attribute, but that position in the attribute set can actually represent different attributes. For example, when filtering on cars, the format of the main fitment data might either be year_make_model, year_make_model_enginetype, year_make_model_submodel, or year_make_model_enginetype_submodel. This greatly reduces the number of compatibility sets needed to be stored—and filters required to search them—by reducing the number of attributes in a given compatibility set. For this example, let's assume that the engine type of “2.5 L” is also specified.

guaranteed_fit_1 CONTAINS “All_All_All_” OR
(ymm_1 CONTAINS “2017_honda_civic” OR ymm_1 CONTAINS
“2017_honda_civic_rx” OR ymm_1 CONTAINS
“2017_honda_civic_2.51” OR ymm_1 CONTAINS
“2017_honda_civic_2.51_rx”) OR
(ymm_2 CONTAINS “2017_honda_civic” OR ymm_2 CONTAINS
“2017_honda_civic_rx” OR ymm_2 CONTAINS
“2017_honda_civic_2.51” OR ymm_1 CONTAINS
“2017_honda_civic_2.51_rx”) OR
(ymm_3 CONTAINS “2017_honda_civic” OR ymm_2 CONTAINS
“2017_honda_civic_rx” OR ymm_3 CONTAINS
“2017_honda_civic_2.51” OR ymm_1 CONTAINS
“2017_honda_civic_2.51_rx”) OR

This set of filters allows for filtering on five separate main fitment attributes, across many arrays as well as including universal parts in the result set.

Not every compatibility attribute may be used for filtering. For example, if only year/make/model are being used to filter, but the search includes additional fitment information about engine type, it is possible to receive products in the result set that do not fit. For this to be possible, they must:
Have a correct year/make/model, or main fitment attributes which are used as the filter).
Have an incorrect engine type, or additional fitment attributes not used as the filter.

The goal is to bury products that do not fit but that the system was unable to filter out. Conversely, it is possible to instead boost products that are known to likely fit. The guaranteed_fit arrays can be used for this purpose.

The system may use a biasing profile to boost matching products by applying specific rules according to provided fitment. For example, the following bias profile is added to search request to make sure all products matching “2017_honda_civic_” are on the top of a result page:

```
}
  guaranteed_fit_1: ANY (“2817_honda_civic_”), boost:
  0.8
}
```

It is noted that boost: 0.8 results in a strong increase. If fitment data has engine specification, it can be added as a second boost used to improve biasing:

[
{ guaranteed_fit_1: ANY (“2017_honda_civic_”), boost:
0.8 },
{ guaranteed_fit_1:
ANY (“2017_honda_civic_engine|0.8”), boost: 0.8 }
]

This results in boosting products that fit and therefore buries products that do not fit. Additionally, it prefers more specific products (as seen in the engine type example) and therefore allows stores to prefer placing non-universal products on the top of their result sets.

The system provides search data including records and related metadata as well as fitment related data about internal processing of a fitment search in the results, although not all data needs to be returned. On a top level of the response there can be provided a “fitment Breakdown” to represent the fitment context used internally such as:

“fitmentBreakdown”: {
“status”: “FITMENT_PROVIDED_SEARCH”,
“year”: “2017”,
“make”: “honda”,
“model”: “civic”,
“other”: null;
“sub_model”: null;
“meta” : {
“parsing_enabled”: true
}
}

Additionally each product record can be enriched with guaranteed fit data used to describe a determined fit. For example, if the product does not fit the record may be specified according to:

“gbi_fit”: {
“fit”: false,
“missing”: [ ]
}

It is noted that the missing array is empty, and as such there are no fitment values that could be added to guarantee a fit. A part can be determined to have Does Not Fit with an entity if ALL of the following are true:
a) The entity information provided has no exact match in all of the guaranteed_fit arrays.
b) The entity information provided is not a proper subset of any of the values in any of the guaranteed_fit arrays.

If (b) is true, then there must be some value in the provided entity information that contradicts values in the guaranteed_fit arrays. If (b) were not true, then either it would be listed as an entry in one of the arrays, or it would simply be missing information and therefore be a subset.

For products that might fit, the fit may be specified according to:

“gbi_fit”: {
“fit”: false;
“missing”: [“engine”, “style form”]
}

The missing array provides all missing fitment attribute keys needed to be further specified in order to guarantee fit between the product and entity.

A part can be determined to have Might Fit with an entity if:
The entity information provided has no direct match in any guaranteed_fit array and is a subset of what can be found there.

In the case that a product might fit, the system may determine the missing attributes that should be specified in order to guarantee fit 712, which may be included in the response as noted above.

For products that are guaranteed to fit the record may be specified according to:

“gbi_fit”: {
“fit”: true
}

The product is expected to fit the entity with no further clarifications required.

A part can be determined to have Guaranteed Fit with an entity if ANY of the following are true:
The entity information provided exactly matches any one entry in a guaranteed_fit array.
The entity information provided is a superset of any one entry in a guaranteed_fit array.

The results can be returned to the user 714. Additionally or alternatively, the results may be further filtered before being returned. For example, only those products that are guaranteed to fit may be returned. The results may be presented to the user in various graphical user interface.

It will be appreciated by one of ordinary skill in the art that the systems, methods and components shown in the figures can include components not explicitly depicted. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

Although certain components and steps have been described, it is contemplated that individually described components, as well as steps, can be combined together into fewer components or steps or the steps can be performed sequentially, non-sequentially or concurrently. Further, although described above as occurring in a particular order, one of ordinary skill in the art having regard to the current teachings will appreciate that the particular order of certain steps relative to other steps can be changed. Similarly, individual components or steps can be provided by a plurality of components or steps. One of ordinary skill in the art having regard to the current teachings will appreciate that the components and processes described herein can be provided by various combinations of software, firmware and/or hardware, other than the specific implementations described herein as illustrative examples.

The techniques of various embodiments can be implemented using software, hardware and/or a combination of software and hardware. Various embodiments are directed to apparatus, e.g. a node which can be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Some embodiments are directed to a computer program product comprising a computer-readable medium comprising code for causing a computer, or multiple computers, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code can be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor can be for use in, e.g., a communications device or other device described in the present application.

Numerous additional variations on the methods and apparatus of the various embodiments described above will be apparent to those skilled in the art in view of the above description. Such variations are to be considered within the scope.

What is claimed is:

1. A method of searching comprising:
receiving a raw search query comprising a plurality of terms from a user;
processing the raw search query by a large language model (LLM) in order to identify one or more product terms of a product being searched and one or more attributes specifying fitment requirements of the product;
performing a vector search for the one or more attributes against a vector database of fitment terms to provide one or more verified fitment attributes, as a first subset of the verified fitment attributes providing main fitment data and a second subset of the verified fitment attributes providing additional fitment data;
performing a filtered product search using the identified one or more product terms as search terms and the main fitment data as a filter, the filtered product search providing a plurality of products matching the search terms and the filter; and
returning the plurality of products to the user.

2. The method of claim 1, further comprising:
determining a fit of each of the plurality of products using the additional fitment data; and
returning the fit of each of the plurality of products to the user.

3. The method of claim 2, wherein the fit of each of the plurality of products is determined to be one of:
guaranteed fit;
possible fit; and
does not fit.

4. The method of claim 3, wherein the fit of at least one of the plurality of products is a possible fit, the method further comprising:
determining one or more fitment attributes required to provide a guaranteed fit.

5. The method of claim 1, further comprising burying/boosting one or more of the plurality of products in the search results.

6. The method of claim 1, wherein the search is performed against a product catalog comprising a plurality of products each associated with one or more fitment values of entities the respective product is compatible with.

7. The method of claim 1, wherein a response from the LLM is cached.

8. The method of claim 7, further comprising determining if the received raw search query has been previously cached.

9. The method of claim 1, wherein returning the plurality of products to the user comprises returning product metadata pertaining to the one or more attributes specifying fitment requirements of the product.

10. The method of claim 1, wherein returning the plurality of products to the user comprises returning metadata and state information based on processing of the raw search query by the LLM.

11. The method of claim 1, further comprising ingesting product information comprising a product information about a plurality of products, the product information including fitment attributes.

12. The method of claim 11, wherein the fitment attributed associated with a product specify entity information that the product fits.

13. The method of claim 11, wherein the fitment attributed associated with a product specify that the product is a universal fit.

14. A non-transitory computer readable medium comprising instructions which when executed configure a computing system to perform a method comprising:
receiving a raw search query comprising a plurality of terms from a user;
processing the raw search query by a large language model (LLM) in order to identify one or more product terms of a product being searched and one or more attributes specifying fitment requirements of the product;
performing a vector search for the one or more attributes against a vector database of fitment terms to provide one or more verified fitment attributes, as a first subset of the verified fitment attributes providing main fitment data and a second subset of the verified fitment attributes providing additional fitment data;
performing a filtered product search using the identified one or more product terms as search terms and the main fitment data as a filter, the filtered product search providing a plurality of products matching the search terms and the filter; and
returning the plurality of products to the user.

15. The computer readable medium of claim 14, further comprising:
determining a fit of each of the plurality of products using the additional fitment data; and
returning the fit of each of the plurality of products to the user.

16. The computer readable medium of claim 15 wherein the fit of each of the plurality of products is determined to be one of:
guaranteed fit;
possible fit; and
does not fit.

17. The computer readable medium of claim 16, wherein the fit of at least one of the plurality of products is a possible fit, the method further comprising:
determining one or more fitment attributes required to provide a guaranteed fit.

18. The computer readable medium of claim 14, further comprising burying/boosting one or more of the plurality of products in the search results.

19. The computer readable medium of claim 14, wherein the search is performed against a product catalog comprising a plurality of products each associated with one or more fitment values of entities the respective product is compatible with.

20. The computer readable medium of claim 14, wherein returning the plurality of products to the user comprises returning product metadata pertaining to the one or more attributes specifying fitment requirements of the product.

21. The computer readable medium of claim 14, further comprising ingesting product information comprising a product information about a plurality of products, the product information including fitment attributes,
wherein the fitment attributed associated with a product specify one or more of:
entity information that the product fits; and
that the product is a universal fit.

22. A computer system comprising:
at least one processor for executing instructions; and
at least one memory storing instructions, which when executed configure the computing system to perform a method according to claim 1.
